(19) United States
(12) Patent Application Publication
(10) Pub. No.: US 2013/0132068 A1
(43) Pub. Date: May 23, 2013

(54) DEVICE, METHOD AND COMPUTER READABLE STORAGE MEDIUM FOR DISPLAYING MULTIPLE LANGUAGE CHARACTERS

(71) Applicants: Ching-Wen LIN, New Taipei City (TW); Yu-Chi HSIEH, Changhua County (TW)

(72) Inventors: Ching-Wen LIN, New Taipei City (TW); Yu-Chi HSIEH, Changhua County (TW)

(73) Assignee: INSTITUTE FOR INFORMATION INDUSTRY, TAIPEI (TW)

(21) Appl. No.: 13/314,203

(22) Filed: Dec. 8, 2011

(30) Foreign Application Priority Data
Nov. 23, 2011 (TW) 100142936

(51) Int. Cl. G06F 17/20

(52) U.S. Cl. 704/8; 704/E11.001

(57) ABSTRACT

A method to display multiple language characters is provided. The method comprises a number of steps. A multiple language character data is stored. The multiple language character data comprises a common character part and a plurality of offset parts. The common character part comprises a plurality of common characters and each of the offset parts comprises a plurality of specific language characters. A selection command is received. One of the offset parts is retrieved according to the selection command. At least one character is displayed on a display module according to the common character part and the selected offset part.

### RELATED APPLICATIONS

This application claims priority to Taiwan Application Serial Number 100142936, filed Nov. 23, 2011, which is herein incorporated by reference.

### BACKGROUND

1. Technical Field

The present invention relates to technology for displaying language characters. More particularly, the present invention relates to a method, a device and a computer readable storage medium to display multiple language characters.

2. Description of Related Art

Technology plays an integral part in the daily life for most people. Electronic devices, multimedia gadgets and computers are things we deal with every day. From simple electronic devices such as clocks, watches, and chips used in home appliances to complicated electronic devices such as cell phones and computer systems, a well-designed interface is necessary for users to operate the devices. Generally, users can read text information shown on the screen of an electronic device to ascertain the operation condition of the electronic device or to know the options that the user can select. However, electronic devices are sold in different countries that use different languages. Hence, electronic devices have to provide characters in different languages on the screen for the users in different countries.

Accordingly, those in this field are endeavoring to design a method, a device and a computer readable storage medium to display multiple language characters, in which the multiple language characters can be stored efficiently.

### SUMMARY

An aspect of the present disclosure is to provide a method to display multiple language characters. The method comprises a number of steps. A multiple language character data is stored, wherein the multiple language character data comprises a common character part and a plurality of offset parts. The common character part comprises a plurality of common characters and each of the offset parts comprises a plurality of specific language characters. A selection command is received. One of the offset parts is retrieved according to the selection command. At least one character is displayed on a display module according to the common character part and the selected offset part.

Another aspect of the present disclosure is to provide a computer readable storage medium to store a computer program to execute a method to display multiple language characters. The method comprises a number of steps. A multiple language character data is stored, wherein the multiple language character data comprises a common character part and a plurality of offset parts. The common character part comprises a plurality of common characters and each of the offset parts comprises a plurality of specific language characters. A selection command is received. One of the offset parts is retrieved according to the selection command. At least one character is displayed on a display module according to the common character part and the selected offset part.

Yet another aspect of the present disclosure is to provide a device to display multiple language characters. The device comprises a storing module, an input module, a retrieving module and a display module. The storing module stores a multiple language character data, in which the multiple language character data comprises a common character part and a plurality of offset parts. The common character part comprises a plurality of common characters and each of the offset parts comprises a plurality of specific language characters. The input module receives a selection command. The retrieving module retrieves one of the offset parts according to the selection command. The display module displays at least one character according to the common character part and the selected offset part.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of a device to display multiple language characters according to an embodiment of the present disclosure

FIG. 2 is a schematic diagram of multiple language character data in an embodiment of the present disclosure; and

FIG. 3 is a flow chart of a method to display, multiple language characters in an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

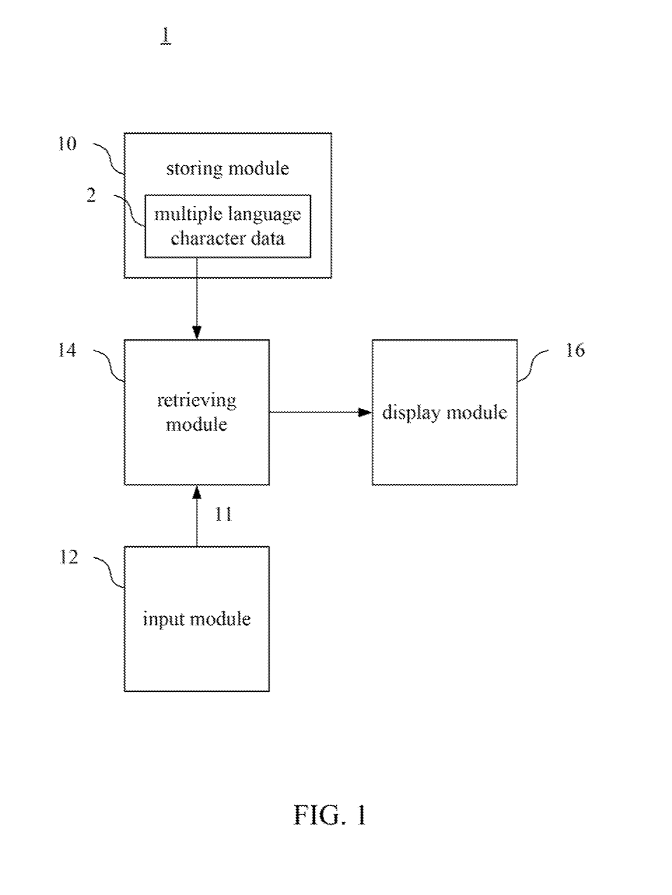

FIG. 1 is a block diagram of a device 1 to display multiple language characters according to an embodiment of the present disclosure. The device 1 comprises a storing module 10, an input module 12, a retrieving module 14 and a display module 16.

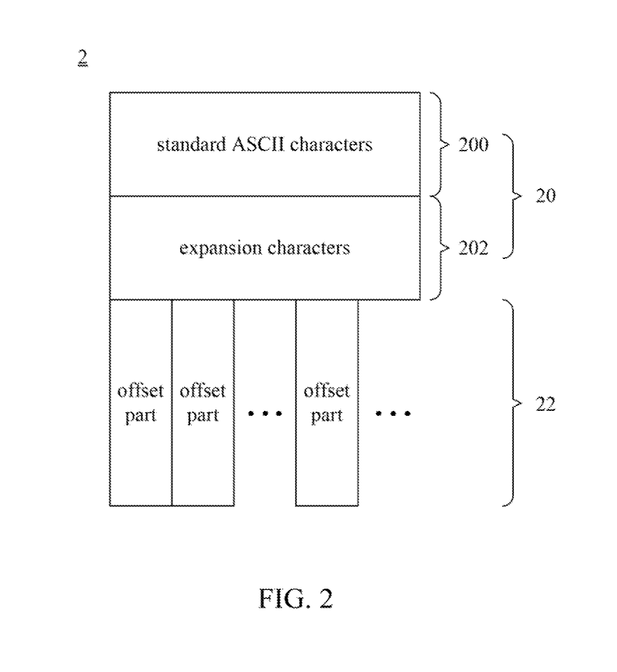

The storing module 10 stores a multiple language character data 2. FIG. 2 is a schematic diagram of the multiple language character data 2 in an embodiment of the present disclosure.

In an embodiment, the multiple language character data 2 is an ISO-8859 character set. The ISO-8859 character set is a series of standards for 8-bit character encodings to encode the characters used in languages that use the Latin alphabet. For example, the ISO-8859-1 character set is used to encode the characters used in the languages in west Europe such as English, French, Spanish, German, etc. The ISO-8859-2 character set is used to encode the characters used in the languages in middle Europe such as Czech, Polish, Hungarian, etc. The ISO-8859-16 character set is used to encode the characters used in Romanian.

In the present embodiment, the multiple language character data 2 comprises a common character part 20 and a plurality of offset parts 22. The common character part 20 comprises common characters that are used in all these languages. For example, the characters b, d and g are the same in these languages. Hence, these characters are common and are categorized in the common character part 20. These common characters can be stored in a first section 200 of standard ASCII characters in the common character part 20. In an embodiment, the common character part 20 further comprises a second section 202 of expansion characters to store characters such as symbols or punctuation marks.

The character ‘a’ in English includes a circumflex accent in the French language to result in the character ‘à’. The character ‘â’ is the third letter of the Romanian alphabet. The character ‘ö’ occurs in the German language and the character ‘ô’ occurs in the Slovak language, while in English the character becomes ‘o’. Accordingly, the characters a, â, à, o, ö and ô are categorized in the offset parts 22. In an embodiment, one of the offset parts 22 stores the specific characters corresponding to certain languages having the same specific characters. For example, the specific characters in English, French, Spanish and German can be stored in one offset part 22 since the specific characters in these languages are almost the same. The specific characters used in Russian are quite different from other languages, and accordingly the specific characters in Russian can be stored in another offset part 22.

Consequently, the multiple language character data 2 is able to categorize all the characters in the ISO-8859 character set into a common character part 20 and a plurality of offset parts 22 such that the common characters can be stored in the common character part 20 and the specific characters that are not common among these languages can be stored in different offset parts 22. In an embodiment, the storing module 10 is a read-only memory (ROM), and each of the common character part 20 and the offset parts 22 are stored in a particular memory section in the read-only memory. For example, the first section 200 of standard ASCII characters in the common character part 2 is stored in the memory block of 0-127 bytes, the second section 202 of expansion characters in the common character part 2 is stored in the memory block of 128-159 bytes and the offset parts 22 are stored in the memory block of 160-255 bytes. In another embodiment, the storing module 10 is a hard disk, a CD-ROM or another type of storing module. The multiple language character data 2 can be stored as a characters data file and can be loaded in the memory when necessary. Hence, the characters in the common character part 20 are only stored once. In an electronic device having a small embedded memory, the memory capacity can be fully utilized since the multiple language character data 2 can be stored using a minimal amount of space.

The input module 12 receives a selection command 11. In different electronic devices, the input module 12 can be a button, a keyboard, a mouse or another kind of input device. The retrieving module 14 retrieves one of the offset parts 22 according to the selection command 11. In an embodiment, when the multiple language character data 2 is a characters data file, the retrieving module 14 retrieves the blocks corresponding to one of the offset parts 22 and loads the blocks into the memory according to the selection command 11. In another embodiment, when the multiple language character data 2 is stored in a read-only memory, the retrieving module 14 can be implemented by a multiplexer to select the memory block corresponding to one of the offset parts 22 through a command or a pin.

The display module 16 displays at least one character according to the common character part 20 and the selected offset part 22. In an embodiment, the display module 16 is a liquid crystal display module or another kind of display module to display the characters of a specific language. In different embodiments, the display module 16 displays the characters according to data in a read-only memory or according to input by the user.

Accordingly, the device of the present disclosure can store the multiple language character data using a minimal amount space by categorizing the character data into a common character part and a plurality of offset parts.

For example, if all the characters in two different languages are stored in the storing module with 8×16 font size, the total amount of the data is (256+256)*16=8192 bytes. If the common characters of the two languages are only stored once as in the present disclosure, the total amount of the data is (256+96)*16=5632 bytes. Accordingly, 31.25% of the capacity of the storing module can be saved. By using the method in the present disclosure, about 60% of the capacity of the storing module can be saved if all the characters from the ISO-8859-1 character set to the ISO-8859-16 character set are stored.

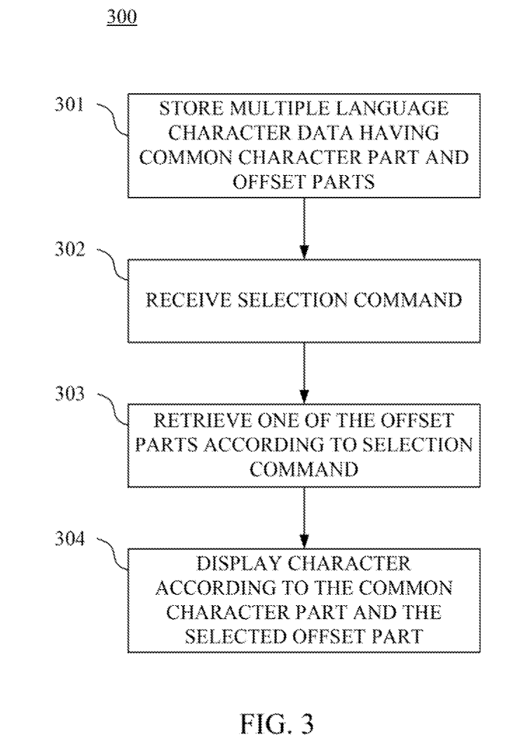

FIG. 3 is a flow chart of a method 300 to display multiple language characters in an embodiment of the present disclosure. The method can be used in the device 1 depicted in FIG. 1. The method can be stored as a computer program, in which the computer program can be stored in a computer readable medium such as a ROM (read-only memory), a flash memory, a floppy disc, a hard disc, an optical disc, a flash disc, a tape, a database accessible from a network, or any storage medium with the same functionality that can be contemplated by persons of ordinary skill in the art to which this invention pertains. The method 300 comprises the steps as outlined below. It is noted that the steps are not recited in the sequence in which the steps need to be performed. That is, unless the sequence of the steps is expressly indicated, the sequence of the steps is interchangeable, and all or part of the steps may be simultaneously, partially simultaneously, or sequentially performed.

In step 301, a multiple language character data 2 is stored in a storing module 10, wherein the multiple language character data 2 comprises a common character part 20 and a plurality of offset parts 22. The common character part 20 comprises a plurality of common characters and each of the offset parts 22 comprises a plurality of specific language characters.

In step 302, the input module 12 receives a selection command 11.

In step 303, the retrieving module 14 retrieves one of the offset parts 22 according to the selection command 11.

In step 304, the display module 16 displays at least one character according to the common character part 20 and the selected offset part 22.

Accordingly, the method of the present disclosure can store the multiple language character data using a minimal amount of space by categorizing the character data into a common character part and a plurality of offset parts.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method to display multiple language characters comprising:
storing a multiple language character data, wherein the multiple language character data comprises a common character part and a plurality of offset parts, in which the common character part comprises a plurality of common characters and each of the offset parts comprises a plurality of specific language characters;
receiving a selection command;
retrieving one of the offset parts according to the selection command; and
displaying at least one character on a display module according to the common character part and the selected offset part.

2. The method of claim 1, wherein the multiple language character data is stored in a read-only memory (ROM), and each of the common character part and the offset parts is stored in a memory section in the read-only memory.

3. The method of claim 1, wherein the multiple language character data is stored as a characters data file.

4. The method of claim 1, wherein the multiple language character data is an ISO-8859 character set.

5. The method of claim 1, wherein the common character part comprises a first section of standard ASCII characters and a second section of expansion characters.

6. A non-transitory computer readable storage medium to store a computer program to execute a method to display multiple language characters, the method comprising the steps of:
storing a multiple language character data, wherein the multiple language character data comprises a common character part and a plurality of offset parts, in which the common character part comprises a plurality of common characters and each of the offset parts comprises a plurality of specific language characters;
receiving a selection command;
retrieving one of the offset parts according to the selection command; and
displaying at least one character on a display module according to the common character part and the selected offset part.

7. The non-transitory computer readable storage medium of claim 6, wherein the multiple language character data is stored in a read-only memory (ROM), and each of the common character part and the offset parts is stored in a memory section in the read-only memory.

8. The non-transitory computer readable storage medium of claim 6, wherein the multiple language character data is stored as a characters data file.

9. The non-transitory computer readable storage medium of claim 6, wherein the multiple language character data is an ISO-8859 character set.

10. The non-transitory computer readable storage medium of claim 6, wherein the common character part comprises a first section of standard ASCII characters and a second section of expansion characters.

11. A device to display multiple language characters comprising:
a storing module to store a multiple language character data, wherein the multiple language character data comprises a common character part and a plurality of offset parts, in which the common character part comprises a plurality of common characters and each of the offset parts comprises a plurality of specific language characters;
an input module to receive a selection command;
a retrieving module to retrieve one of the offset parts according to the selection command; and
a display module to display at least one character according to the common character part and the selected offset part.

12. The device of claim 11, wherein the storing module is a read-only memory (ROM), and each of the common character part and the offset parts is stored in a memory section in the read-only memory.

13. The device of claim 11, wherein the multiple language character data is stored as a characters data file.

14. The device of claim 11, wherein the multiple language character data is an ISO-8859 character set.

15. The device of claim 11, wherein the common character part comprises a first section of standard ASCII characters and a second section of expansion characters.

16. The device of claim 11, wherein the display module is a liquid crystal display (LCD) module.

17. The device of claim 11, wherein the retrieving module comprises a multiplexer to retrieve one of the offset parts according to the selection command.
